(19) United States
(12) Patent Application Publication
(10) Pub. No.: US 2015/0239387 A1
(43) Pub. Date: Aug. 27, 2015

(54) LIFT ASSEMBLY

(71) Applicant: Infonet Corporation dba Summit Products, Inc., Altoona, IA (US)

(72) Inventors: Albert Marasco, Clive, IA (US); Charlie Brown, Des Moines, IA (US)

(73) Assignee: Infonet Corporation dba Summit Products, Inc., Altoona, IA (US)

(21) Appl. No.: 14/187,860

(22) Filed: Feb. 24, 2014

(51) Int. Cl. B60P 3/39; A47C 17/84; A47C 19/04; A47C 17/80

(52) U.S. Cl. CPC B60P 3/39; A47C 17/80; A47C 17/84; A47C 19/045

(57) ABSTRACT

A lift assembly is provided. In one embodiment, the lift assembly may be used to raise and lower a bed, such as in a recreational vehicle. The lift may include a platform assembly which is movable between upper and lower positions. The lower position may be located in a lower horizontal plane than the upper position. The lift assembly may further include at least one movable member connected to the platform assembly and which may be activated to perform functions selected from the group consisting of raising the platform assembly, lowering the platform assembly, and combinations thereof. The lift assembly may also include means for positioning the platform assembly in the lower horizontal plane. In some embodiments, the means may be a cradle, while in other embodiments, the means may be a latch. The assembly may include a plurality of movable members which are activated by an electric motor.

### FIELD OF THE INVENTION

The present invention relates to a lift assembly. More specifically, the present invention relates to a lift assembly having a platform which is movable between upper and lower positions and including at least one means to position the platform in the lower position.

### BACKGROUND

Vehicles, such as recreation vehicles, motor homes, semi-trucks, boats, and trailers, oftentimes include sleeping accommodations. However, all of these vehicles also have limited space. Accordingly, the vehicles require a balance between providing a large number of comfortable beds, other amenities, and space to move around the vehicle. Unfortunately, a bed has a large footprint and, therefore, can require a lot of floor space in the vehicle, particularly if located directly on the floor. This problem is magnified in a vehicle, as compared with a bed located in a permanent home. Therefore, vehicles sometimes include beds that may be raised from the floor so that other items may be located below the bed. A raised bed works well because when users are sleeping, they are generally not using other amenities in the vehicle. Similarly, when users are using other amenities in the vehicle, they are generally not sleeping. In addition, sometimes beds have been hidden in couches and dining areas. More recently, designs exist to raise and lower the bed. This configuration provides clearance for users to utilize space below the bed when in the raised position. Furthermore, such a design provides sufficient room for a user to sleep in the bed when in the lower position. However, even in the lower position, the bed is still not located directly on the floor. This allows other parts of the vehicle to be located permanently underneath the bed.

In one example of such a movable bed, U.S. Pat. No. 7,610,636 discloses an in-vehicle lift mechanism. The mechanism includes a lateral bed frame that travels vertically within an upright frame assembly. The upright frame assembly includes four posts at the corners of the lift assembly. A system of flexible members, such as cables, raises and lowers the bed. A drive unit provides the power to wind and unwind the flexible members, which are guided by a guide arrangement. U.S. Pat. No. 7,347,484 discloses a similar bed lift mechanism for a trailer wherein the bed is raised and lowered via four chains. Also included are four vertical track members located at the corners of the bed. The four vertical track members are attached to opposite walls of the trailer. U.S. Pat. Nos. 6,657,273 and 8,038,193 both disclose bed lift assemblies wherein only two vertical guide members may be utilized. In particular, the '193 patent includes two guide members which prevent the bed from swinging as the bed moves between the raised and lowered position.

In another example, U.S. Pat. No. 6,507,962 discloses a ceiling mounted sleeping system. The system includes a sleeping platform and a ceiling support. The ceiling support employs a winch and cables that are configured in an “H” shape for raising and lowering the sleeping platform. Furthermore, the sleeping platform includes telescoping, pivotable legs to support the sleeping platform in the lowered, sleeping position.

In addition, U.S. Patent Application Publication No. 2007/0226901 discloses a lift mechanism having two positioning systems. In one system, a motorized pulley system positions the bed vertically. In the other system, a vertical rail and roller system positions the bed horizontally. A motor raises and lowers four straps via a winch wheel. The rollers are located at the bed frame corners and are received within channels of the rails as the frame is moved up and down. In yet another example, U.S. Pat. No. 7,874,026 discloses a counterweight system to raise and lower a bed without a motor.

U.S. Pat. No. 5,984,404 discloses a vehicle, specifically a semi-truck with a bed raising and lowering system. The system includes elongated straps which are wound and unwound to raise and lower the bed. In the lower position, the bed rests on a shelf to support the weight of the bed. In addition, the bed includes vertical guide rails to aid with movement and positioning of the bed.

The above designs all have a drawback by requiring a vertical frame, guide rails, or guide posts (collectively “vertical guides”). In some cases, these vertical guides must be attached to at least one, if not two, walls. Accordingly, the location of these beds in a vehicle is limited. Even if not attached to a wall, the prior art configurations include vertical guides that remain hanging from the ceiling, even when the bed is in the raised, storage position. Therefore, use of the space underneath the bed is still limited. For example, users cannot walk under these designs without avoiding the vertical guides. In addition, the vertical guides detract from the aesthetics of the vehicle and are visually incongruous. Therefore, designers often try to design the vertical guides into the room. Sometimes rather than a small post, the vertical guide may be a board or larger structure so as to fit with the overall design of the vehicle. However, as a result of the vertical guides, the placement of the bed within the vehicle is limited.

Furthermore, these assemblies are particularly difficult to incorporate into the area above the driver's and passenger's seats at the front of a vehicle, such as a recreational vehicle or motor home. Vertical guides interfere with the sloped windshield, side windows, seat belts, seats, and passenger egress. Yet, this is space that the industry would like to exploit. Furthermore, it is desirable to provide some mechanism for securing the bed in its lowered position. Accordingly, there exists a need in the art for a bed lift assembly which eliminates vertical guides while still positioning the bed in the lower position.

### SUMMARY

Provided is an improved lift assembly. In one embodiment, the lift assembly includes a platform assembly that is movable between an upper position and a lower position. Specifically, the lower position is located in a lower horizontal plane than the upper position. The lift assembly further includes at least one movable member connected to the platform assembly which may be activated to perform functions selected from the group consisting of raising the platform assembly, lowering the platform assembly, and combinations thereof. In addition, the lift assembly includes means for positioning the platform assembly in the lower horizontal plane. The movable member may be selected from the group consisting of a web belt, cable, strap, chain, stretch resistant fabric, and combinations thereof. For example, the movable member may be a web belt.

In some embodiments, the lift assembly may include a plurality of movable members. The movable members may be activated to perform the functions of raising and lowering the platform assembly by an electric motor. Specifically, the electric motor may be a tubular motor. The lift assembly may further include a brake, such as a spring actuated rubber faced disc, to selectively resist motion of the electric motor. In another embodiment, the lift assembly may include a lock assembly to prevent downward movement of the platform assembly. In particular, the lock assembly may have a locked position and an unlocked position, and the lock assembly may be in contact with the platform assembly in the locked position to prevent downward movement of the platform assembly. The lift assembly may also include a privacy member.

In another embodiment, a lift assembly is provided including a platform assembly comprising a bed, the platform assembly being movable between an upper position and a lower position. The lower position is located in a lower horizontal plane than the upper position. Additionally, the lift assembly includes at least one movable member that is connected to the platform assembly and may be activated by a motor to perform functions selected from the group consisting of raising the platform assembly, lowering the platform assembly, and combinations thereof. The lift assembly also includes at least one cradle which receives the platform assembly in the lower position and positions the platform assembly in the lower horizontal plane. The cradle may include a horizontal portion and at least one vertical portion. For example, the cradle may include two vertical portions.

The lift assembly may further comprise a plurality of movable members. Moreover, the lift assembly motor may be an electric motor, and more specifically, an electric motor providing rotational movement to raise and lower the plurality of movable members. Furthermore, the lift assembly may include a lock assembly to prevent downward movement of the platform assembly. In one embodiment, the lock assembly may have a locked position and an unlocked position, with the lock assembly in contact with the platform assembly in the locked position to prevent downward movement of the platform assembly.

In yet another embodiment, a lift assembly includes a platform assembly including a bed and that is movable between an upper and a lower position. The lower position is located in a lower horizontal plane than the upper position. The lift assembly further includes at least one movable member connected to the platform assembly and which may be activated by a motor to perform functions selected from the group consisting of raising the platform assembly, lowering the platform assembly, and combinations thereof. In addition, the lift assembly further includes at least one latch. The latch positions the platform assembly in the horizontal plane. The lift assembly may include a plurality of movable members, which are activated by an electric motor providing rotational movement to raise and lower the plurality of movable members. The lift assembly may also include a lock assembly to prevent downward movement of the platform assembly. The lock assembly may have a locked position and an unlocked position wherein the lock assembly is in contact with the platform assembly in the locked position to prevent downward movement of the platform assembly.

### BRIEF DESCRIPTION OF THE DRAWINGS

FIG. 1A is a perspective view according to one embodiment of a lift assembly of the present invention, wherein the lift assembly is located in a vehicle and is in the lower position.

FIG. 1B is perspective view of the lift assembly of FIG. 1A, wherein the lift assembly is in the upper position.

FIG. 2 is perspective view of the lift assembly of FIGS. 1A and 1B removed from the vehicle.

FIG. 3A is a perspective view of a tubular motor of the lift assembly of FIG. 2.

FIG. 3B is an exploded view of the tubular motor of FIG. 3A.

FIG. 4 is a perspective view of the lift assembly of FIG. 2 wherein the platform assembly frame is raised near the upper position.

FIG. 5A is a cross-section of the lift assembly taken along the lines 5-5 in FIG. 4 and specifically showing the path of two movable members in the lift assembly.

FIG. 5B is a perspective view of one end of the tubular motor of FIG. 5A.

FIG. 5C is a perspective view of the attachment of a movable member to the retaining pin of FIG. 5B.

FIG. 6A is a perspective view of a cradle of the lift assembly of FIGS. 1A and 1B.

FIG. 6B is a perspective view of the cradle of FIG. 6A receiving the platform assembly of the lift assembly of FIGS. 1A and 1B.

FIG. 7A is a side elevational view of the locking assembly of the lift assembly of FIG. 2 in the locked position.

FIG. 7B is a side elevational view of the locking assembly of the lift assembly of FIG. 2 in the unlocked position.

FIG. 8 is a schematic of an electrical wiring system according to an embodiment of a lift assembly of the present invention.

FIG. 9 is a perspective view according to a second embodiment of a lift assembly of the present invention, wherein the lift assembly includes privacy members.

FIG. 10A is a perspective view according to a third embodiment of a lift assembly of the present invention, wherein the lift assembly includes two latches.

FIG. 10B is a perspective view of a latch of the third embodiment of a lift assembly of FIG. 10A.

### DETAILED DESCRIPTION

The following is a detailed description of an embodiment of a lift assembly 100 of the present invention. For ease of discussion and understanding, the following detailed description and illustrations often refer to the lift assembly 100 for use with a bed, and in particular, a bed lift assembly located in a recreational vehicle or motor home. However, it should be appreciated that the lift assembly 100 may also be used in other applications known now or in the future. For example, a lift assembly 100 of the present invention may be used in a warehouse, a cabinet, or in any other lifting application, such as with cattle. In addition, the assembly 100 can be used in any type of vehicle, including a boat, yacht, or other type of passenger ship or vehicle. Oftentimes, boats include curved walls, which make the use of vertical guides difficult or impossible. Accordingly, those vehicles would benefit from the freedom of design of the present invention. To that end, an advantage of the present invention is its ability to fit in irregular shaped areas and rooms.

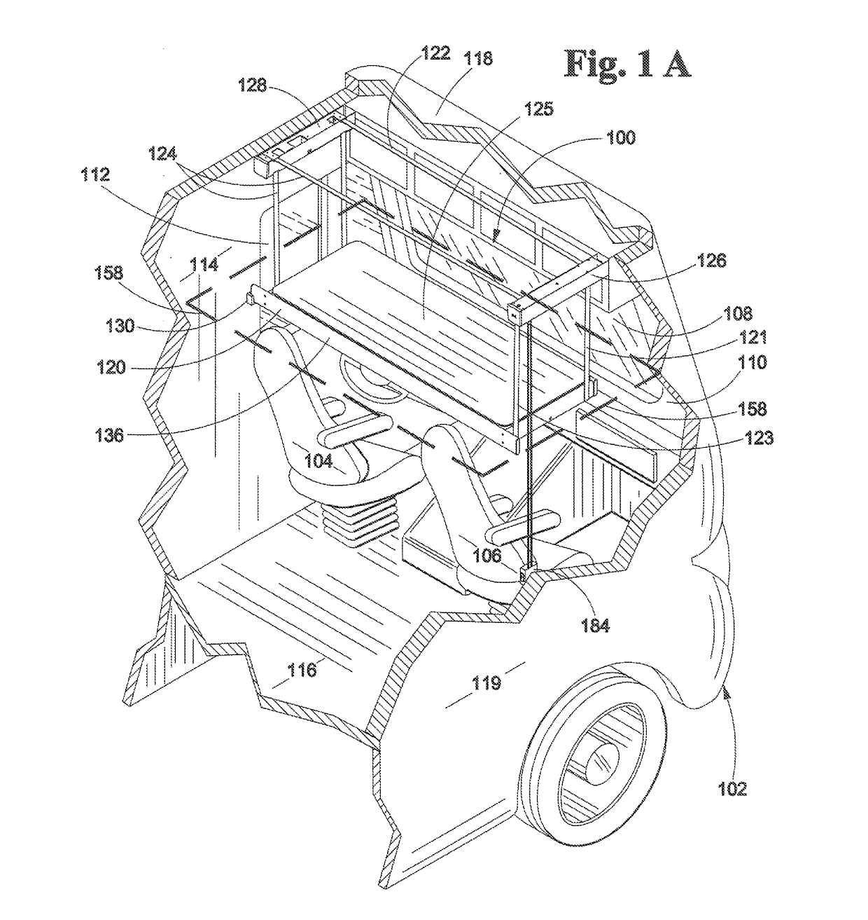

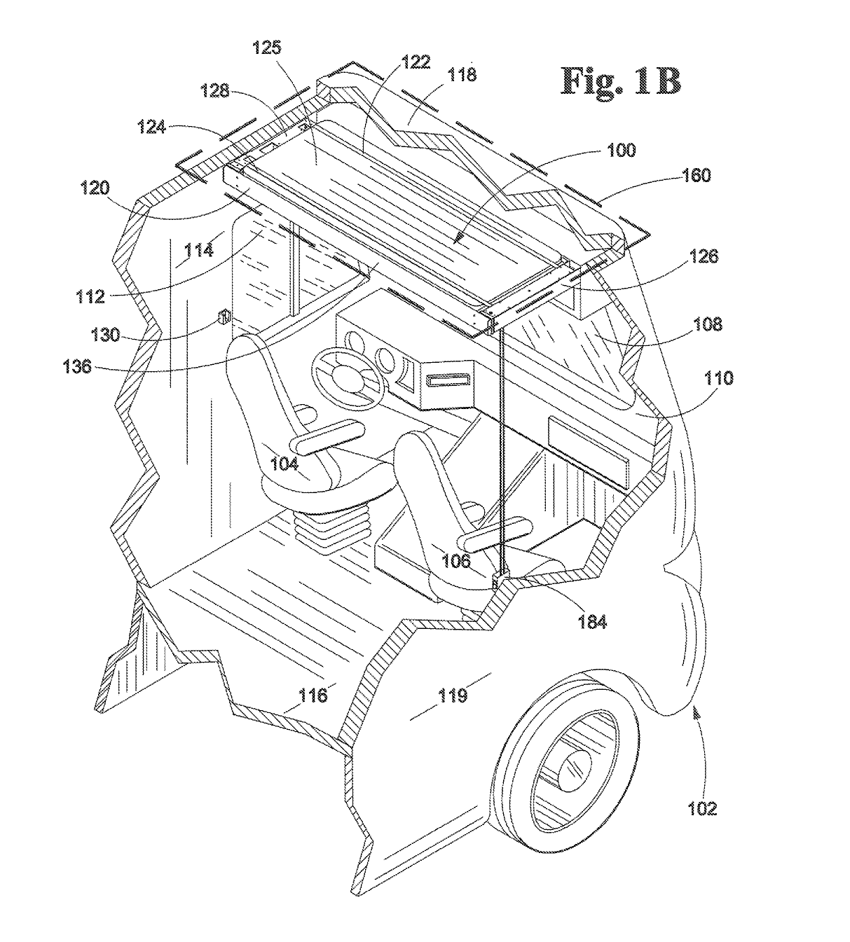

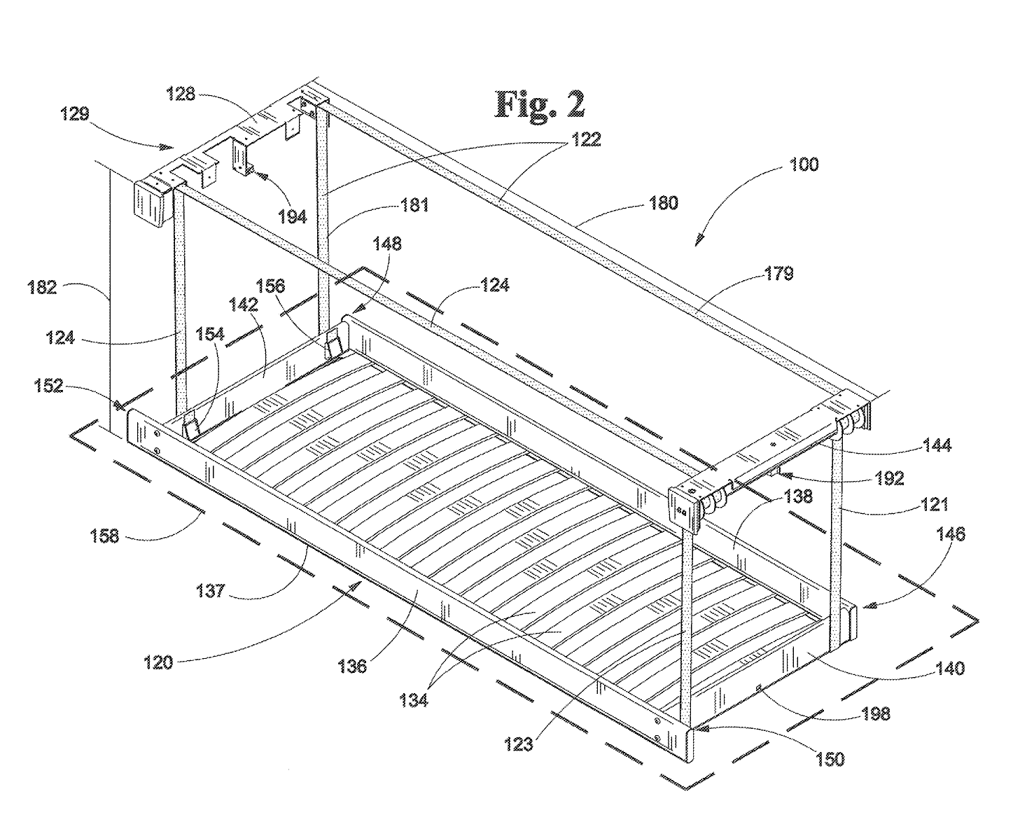

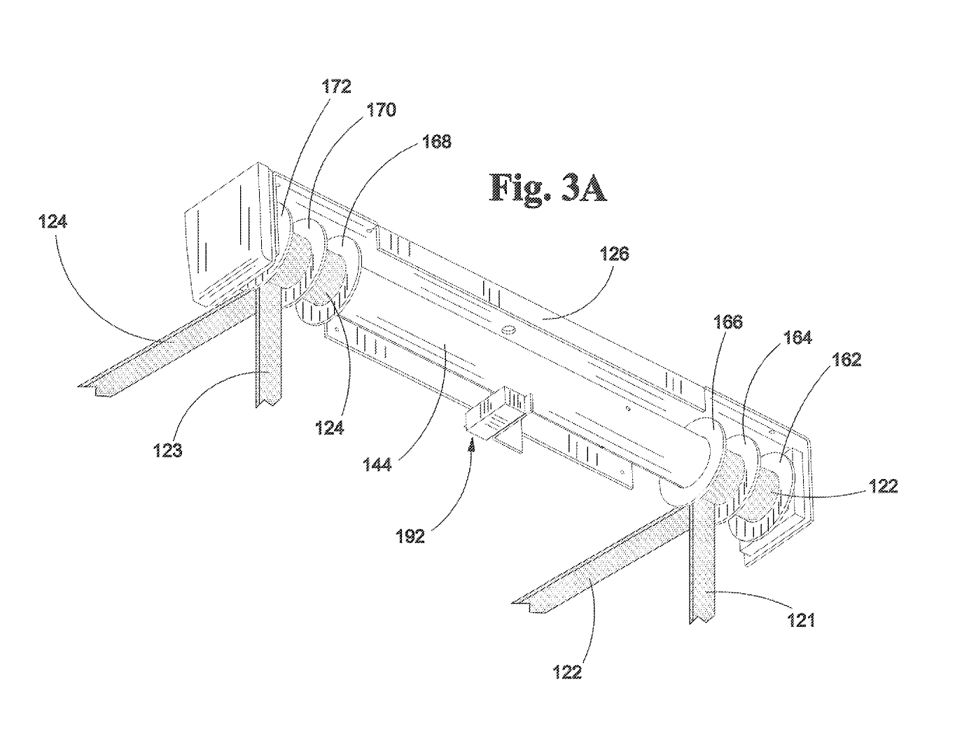

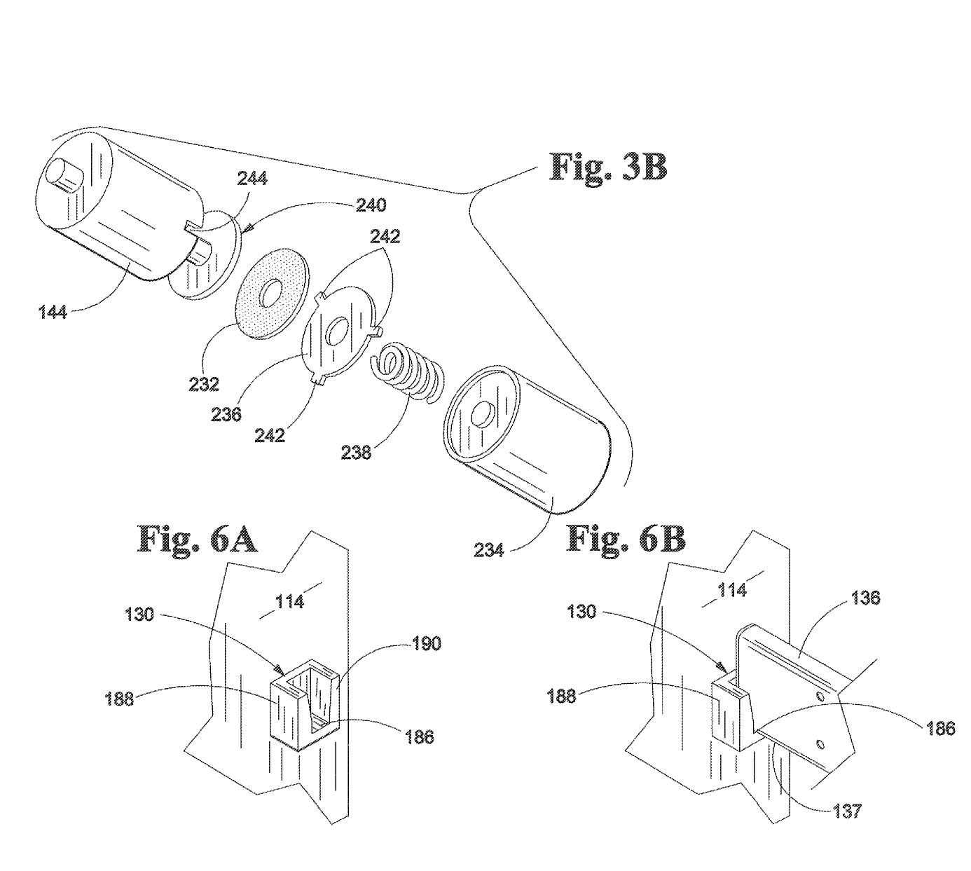

Referring to FIG. 1A, a lift assembly 100 (sometimes “assembly”), specifically a bed lift assembly is shown. In the illustrated embodiment, the assembly 100 is located inside a vehicle, and in particular a recreational vehicle (sometimes “RV”) 102. In the RV 102 of FIG. 1A, the assembly 100 is located above a driver's seat 104 and passengers seat 106. However, the assembly 100 may be located anywhere in the RV 102. The RV 102 also includes a windshield 108 located on a front wall 110 and a driver's window 112 located on a driver's side wall 114. In addition, the RV 102 includes a floor 116, ceiling 118, and passenger side wall 119. The passenger side wall 119 is similar to the driver's side wall 114, although the passenger's window is not shown. The assembly 100 includes a platform assembly 120, four movable members 121, 122, 123, 124 connected to the platform assembly 120, and a drive motor 144 (shown in FIG. 3A). In the preferred embodiment, the movable members are web belts. However any type of movable member known in the art, now or in the future may be used. For example, cables, straps, stretch resistant fabric, or chains may be used. Furthermore, any number of movable members may be used. In some embodiments one movable member may be used, although other embodiments may include a plurality of movable members. The movable member(s) may be narrow, as shown in FIG. 1A, or the movable member(s) may be wide, such as in the case of using a single strap or other fabric. In addition, in the preferred embodiment, the drive motor 144 (hereinafter “motor”) is an electric tubular motor located within a motor housing 126. However, one of skill in the art will understand that other types of motors may be used, such as a hydraulic or non-tubular motor. The motor 144 and movable members 121, 122, 123, 124 function to raise and lower the platform assembly 120 between upper and lower positions. Opposite the assembly from the motor housing 126 is a second housing 128 located on the relay side 129 (shown in FIG. 2) of the assembly, the contents of which will be discussed in further detail below. Furthermore, referring again to FIG. 1A, the assembly 100 includes at least one means for positioning the platform assembly 120 in a lower horizontal plane 158, as will be discussed in further detail below. In the embodiment of FIG. 1A, the means for positioning the platform assembly 120 in the lower horizontal plane is a cradle 130, which receives the platform assembly 120 in the lower position. However, other means may also be employed, as will be discussed in further detail below.

FIG. 1A depicts the platform assembly 120 in the lower position, which in this embodiment is a sleeping position. To that end, a sleeping surface, such as a mattress 125, is provided on the platform assembly 120. The movable members 121, 122, 123, 124, which are connected to the platform assembly 120, may be activated to raise and/or lower the platform assembly 120. In the preferred embodiment, the movable members 121 122, 123, 124 are activated by the motor 144 to raise and lower the platform assembly 120, as will be discussed in further detail below. Turning to FIG. 1B, the assembly 100 is shown in the upper position. In the upper position, the platform assembly 120 is located near the ceiling 118 of the RV 102 in an upper horizontal plane 160. In this position, users of the RV 102 may comfortably sit in the driver's seat 104 and passenger's seat 106. Furthermore, the lift no longer blocks a user's view out the windshield 108, driver's window 112, and passenger's window (not shown). Accordingly, the user may safely drive the RV 102 with the lift in the upper position. FIG. 1B also provides a view of the entire cradle 130. As mentioned above, the cradle 130 receives the platform assembly 120 in the lower position and positions the platform assembly 120 in the lower position.

Turning to FIG. 2, the lift assembly 100 of FIGS. 1A and 1B is shown in Further detail, removed from an RV 102 and in the lower horizontal plane 158. Shown is the platform assembly 120. In the illustrated embodiment, the platform assembly 120 is made of a plurality of laterally extending slats 134 extending between first 136 and second 138 longitudinal frame members. First 140 and second 142 lateral frame members are located at the ends of the platform assembly 120. The four movable members 121, 122, 123, 124 are also shown. The four movable members 121, 122, 123, 124 are connected to the motor 144. The motor 144 can be seen in FIG. 2, but is shown in further detail in FIGS. 3A and 3B. The motor 144 is preferably an electric, tubular motor. However, it will be appreciated that the motor 144 may be any type of motor known in the art, know or in the future. For example, the motor 144 could be hydraulic or a non-tubular type. In another embodiment, the motor may be replaced by a spring in torsion. The spring is pre-loaded to allow a person to raise and lower the platform assembly 120 by hand, similar to garage door assembly. In addition, counterweights could provide a similar non-motorized assembly. In the preferred embodiment employing a motor, each of the movable members 121, 122, 123, 124 are connected to the motor, either directly or indirectly depending on the application, such that the motor may activate the movable members 121, 122, 123, 124 to raise and/or lower the platform assembly 120. In some embodiments, multiple motors may be used. It is anticipated that in such an embodiment, one motor may be located at each end of the assembly 100, controlling only the movable member(s) at the end where it is located. The multiple motors would run as simultaneously as possible to lift the platform assembly 120 in a level manner. However, other configurations may be employed without departing from the scope of the present invention.

Returning again to FIG. 2, the four movable members 121, 122, 123, 124 are each connected to the platform assembly near one of the four corners 146, 148, 150, 152. Two movable members 121, 123 are connected to the platform assembly 120 near the corners 146, 150 closest to the motor 144. The two other movable members 122, 124 are connected to the platform assembly 120 near the corners 148, 152 furthest from the motor 144 at first 154 and second 156 connection points. In the preferred embodiment, the connection points 154, 156 are retaining buckles, also called plastic cam buckles. However, the connection points 154, 156 may be any type of connection known now or in the future. As will be appreciated by one skilled in the art, the two movable members 121, 123 connected to the platform assembly 120 near the corners 146, 150 closest to the motor 144 may be shorter in length than the two movable members 122, 124 connected to the platform assembly 120 near the corners 148, 150 furthest from the motor 144. In this way, the platform assembly 120 may be raised and lowered in a level position. In the lower position, the platform assembly 120 is located in a lower horizontal plane 158, sometimes referred to as the second horizontal plane.

In the preferred embodiment, the assembly 100 may also include a lock in the form of a brake that resists rotary motion of the motor. Referring to FIG. 3B, the brake may be a spring-actuated rubber-faced clutch disc 232. Furthermore, an electric signal may actuate an electric solenoid 234 to retract a pressure plate 236 thereby compressing the pressure plate spring 238 and, in turn, the brake 232, to allow movement of the motor 144. When the solenoid 234 is not actuated, the pressure plate spring 238 pushes on the pressure plate 236 which in turn presses the rubber clutch disc 232 against the electric motor flywheel 240, which stops the movement of the electric motor 144 with gear reduction. The pressure plate 236 resists rotation by means of one or more tabs 242 which engage corresponding slots 244 in the tube which encases the motor components. Therefore, when the brake 232 is in its default, non-actuated position, it prevents rotation of the motor 144 and, accordingly, movement of the platform assembly 120. As such, it is a fail-safe device which prevents movement of the platform assembly 120 in the event of a power loss. One of skill in the art will recognize that a brake need not be employed and that other types of brakes may be used in place of or in addition to the above-described spring actuated rubber faced disc brake.

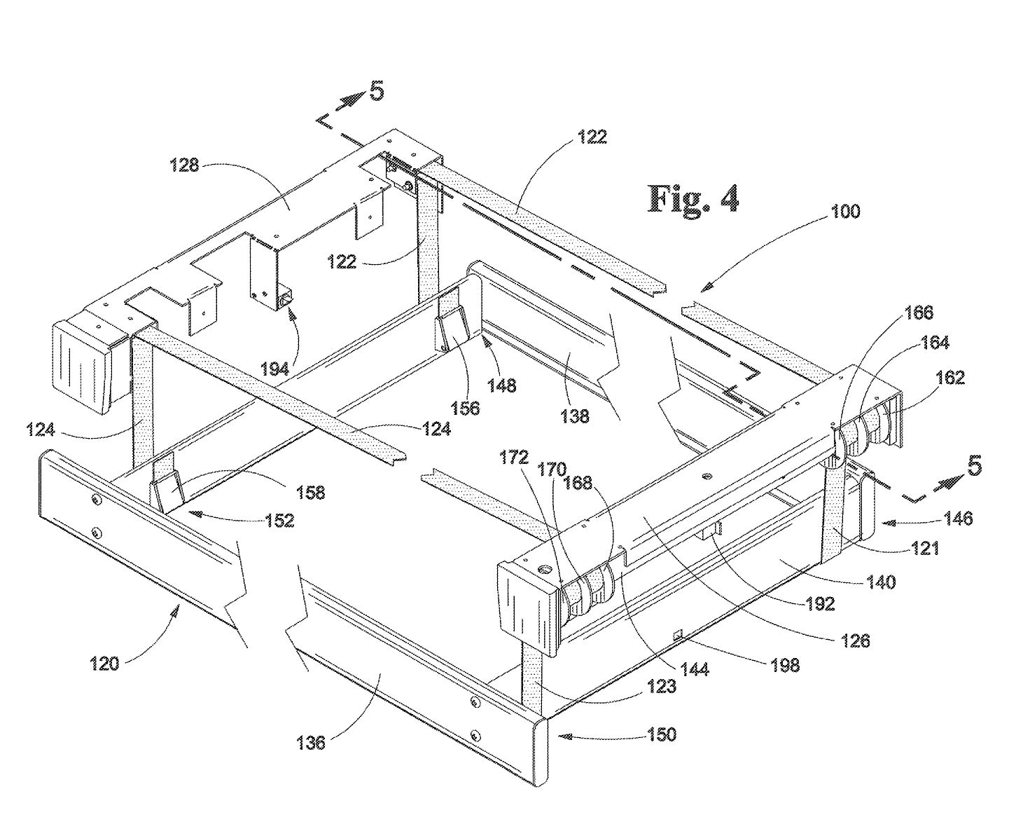

Referring to FIG. 1B, the platform assembly 120 is shown in the upper position, which is located in the upper horizontal plane 160. Turning to FIG. 4, the movement of the platform assembly is carried out by the cooperative movement of the motor 144 and movable members 121, 122, 123, 124. Specifically, the motor is actuated by a switch 184, as will be discussed in further detail below, which causes rotational movement of the motor 144. As the motor 144 rotates, the movable members 121, 122, 123, 124 are wound around the motor 144, causing the movable members 121, 122, 123, 124 to be shortened, thus raising the platform assembly 120. As will be appreciated by one skilled in the art, the movable members 121, 122, 123, 124 need not wrap directly around the motor 144. For example, in one embodiment, the movable members 121, 122, 123, 124 may wrap around spools which are connected to the motor 144, such as at the ends of the motor. Referring to FIG. 3A, in the preferred embodiment, the motor 144 includes six guides 162, 164, 166, 168, 170, 172 to guarantee proper winding and unwinding of the movable members 121, 122, 123, 124. However, it is contemplated that other mechanisms may be used to ensure proper movement of the movable members 121, 122, 123, 124.

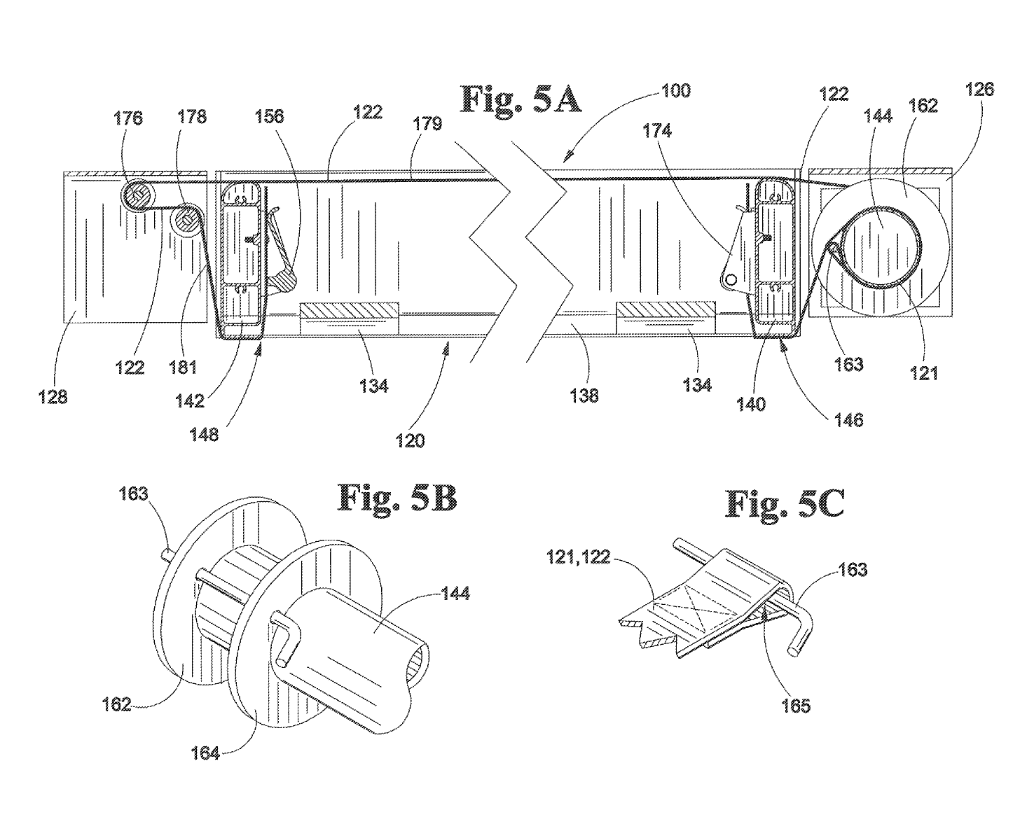

FIG. 5A provides a cross-sectional view of the path of two movable members 121, 122 in the lift assembly 100 when the platform assembly 120 is in the raised position. Both movable members 121, 122 wrap around the motor 144. Guide 162 separates the movable members 121, 122, as they wrap around the motor 144. Movable member 121 is located in front of the guide 162, while movable member 122 is located behind the guide 162. As can be seen in FIGS. 5B and 5C, the movable members 121, 122 are each attached to a retaining pin 163 by a loop 165 at the end of the movable member 121, 122. The retaining pin 163 is threaded through slots in the guides 162, 164. Accordingly, the movable members 121, 122 are retained securely in place as the motor 144 rotates.

Referring again to FIG. 5A, the shorter movable member 121 is connected to the platform assembly 120 near the corner 146 nearest the motor 144. Specifically, the movable member 121 is connected at a third connection point 174. In the preferred embodiment, the third connection point 174 is a retaining buckle, also called a plastic cam buckle; however, any type of connection known now or in the future may be used. The longer movable member 122 is connected to the platform assembly 120 near the corner 148 that is furthest from the motor 144. The longer movable member 122 is connected at the second connection point 156. As shown in FIG. 2, the longer movable member 122 includes a horizontal portion 179 wherein it spans the length 180 of the assembly 100. The longer movable member 122 also includes a vertical portion 181 wherein it spans the height 182 of the assembly. The length 180 of the assembly 100 remains constant, while the height 182 of the assembly is variable, depending on the position of the platform assembly 120. Returning to FIG. 5A, the movable member 122 travels around first and second pulleys 176, 178, to transition from the horizontal portion 179 to the vertical portion 181. The first and second pulleys 176, 178 are located in the second housing 128, opposite the assembly 100 from the motor 144.

Accordingly, as the motor 144 provides rotational movement, the movable members 121, 122 work in cooperation with the motor to raise and lower the platform assembly 120. As the motor 144 rotates to raise the bed, which may be clockwise or counterclockwise depending on the particular application, both movable members 121, 122 are equally wrapped around the motor 144. The shorter movable member 121 does not include a horizontal portion. In addition, the longer movable member 122 horizontal portion 179 remains a constant length. Therefore, the length of each movable member 121, 122 that is lost due to winding around the motor 144 only affects the vertical position of the platform assembly 120. The opposite movement by the motor 144 causes the platform assembly 120 to lower. As the motor 144 rotates to lower the platform assembly 120, which again may be clockwise or counterclockwise depending on the particular application, both movable members 121, 122 are unwrapped from around the motor 144. As the longer movable member 122 horizontal portion 179 remains a constant length, the length of each movable member 121, 122 that is gained due to the unwinding from the motor 144 on affects the vertical position of the platform assembly. As such, the platform assembly is lowered to the lower position. In this configuration, the motor 144 is located near the ceiling 118 of the RV. Although one of skill in the art will recognize that other configurations maybe employed, the illustrated design provides the advantage of providing electricity to the motor 144 through the ceiling 118 of the RV 102. On the other hand, a motor 144 mounted to the platform assembly 120 would require complicated, alternate electrical delivery system.

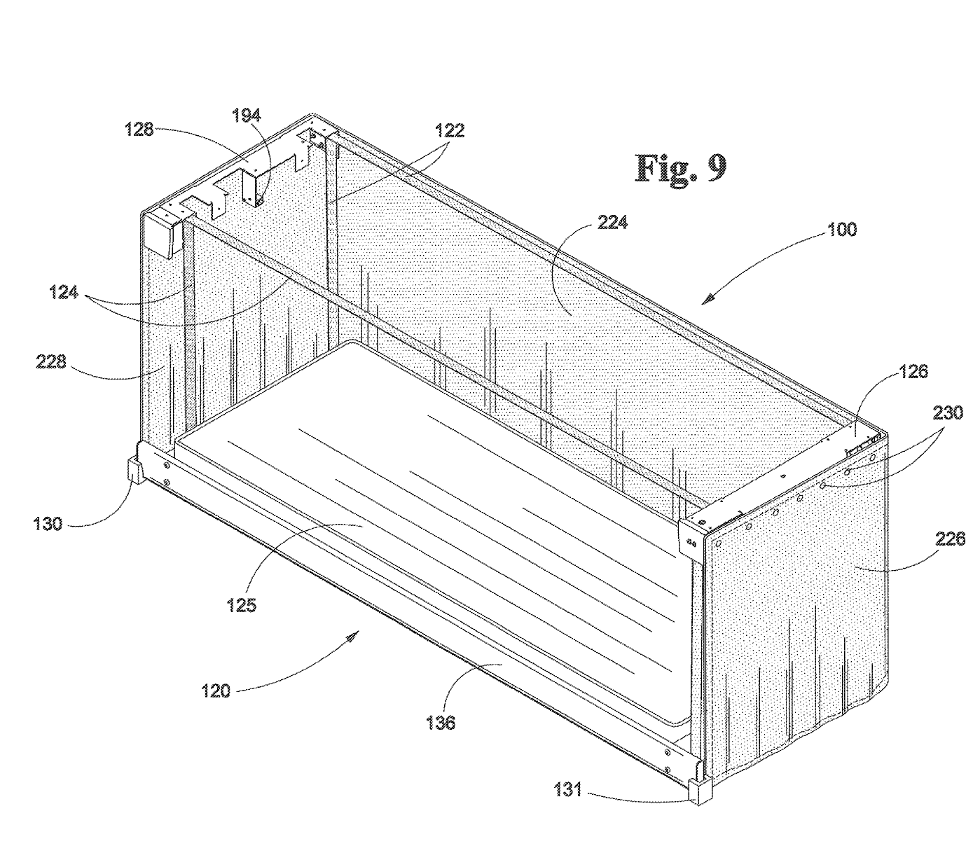

Referring to FIG. 1A, a cradle 130 may receive the platform assembly 120 in the lower position. Specifically, the cradle 130 may position the platform assembly 120 in the lower, or second horizontal plane 158. In the preferred embodiment, the movable members 121, 122, 123, 124 support the weight of the platform assembly 120, including any load that the platform assembly 120 may carry, such as a person in the case of a bed lift. However, the movable members 121, 122, 123, 124 may allow the platform assembly 120 to swing during raising and lowering, as well as once the bed reaches the lower horizontal plane 158. This swinging may be undesirable, particularly while a user is asleep on the platform assembly 120. Accordingly, the cradle 130 positions and stabilizes the platform assembly 120 in the lower horizontal plane 158. In the preferred embodiment, the movable members 121, 122, 123, 124 are a predetermined length that only allows the platform assembly 120 to reach a lower position that is very near to the cradle 130. In other words, the lengths of the movable members 121, 122, 123, 124 preferably do not allow the platform assembly 120 to move below the cradle. The platform assembly 120 may float in the lower position. As such, the cradle 130 primarily positions the platform assembly 120 in the horizontal position, although it is anticipated that the cradle will also position the platform assembly 120 vertically to some extent. Of course, it is anticipated that in some embodiments of the assembly 100, the cradle(s) 130 may support and/or position the platform assembly 120 in its vertical position, also. The assembly includes at least one cradle 130, but may include a plurality of cradles 130, 131 (shown in FIG. 9). In FIG. 1A. a cradle 130 is shown on the driver's side wall 114 of the RV 102. In the preferred embodiment, a second cradle (not shown) is located on the passenger side wall 119 opposite the cradle 130 on the driver's side wall 114. Accordingly, in the preferred embodiment, a pair of cradles 130 is employed at opposite ends of the bed.

Turning to FIGS. 6A and 6B, a cradle 130 is shown in further detail. The cradle 130 includes a horizontal portion 186 and at least one vertical portion 188. The illustrated embodiment includes two vertical portions 188, 190. The cradle may be made of plastic, metal, wood, or any other suitable material. As shown in FIG. 6B, movement of the platform assembly 120 is accomplished via the engagement of longitudinal frame member 136 into cradle 130, which limits movement in the fore, aft, and lateral directions, as well the downward vertical direction. The cradle 130 receives the first longitudinal frame member 136 of the platform assembly 120. Referring to FIG. 2, the first longitudinal frame member 136 may include a bottom surface 137. Focusing again on FIGS. 6B and 1A, the cradle 130 horizontal portion 186 receives the bottom surface 137 of the longitudinal frame member 136. The first vertical portion 188 prevents the platform assembly 120 from swinging in the lower horizontal plane 158. Furthermore, the second vertical portion 190 also prevents the platform assembly 120 from swinging in the lower horizontal plane 158. As one of skill in the art will appreciate, the cradle 130 need not include a second vertical portion 190, although it may be advantageous in some embodiments. In the preferred embodiment, two cradles 130, 131 are provided in the RV 102 to capture or position the platform assembly 120 at two of the four corners. In embodiments employing two cradles 130, 131, the cradles 130, 131 may be located at any two of the four corners. The cradle 130 eliminates the need for intrusive vertical guides to guide the platform assembly 120 as it is raised and lowered. Therefore, the living space of the RV 102 is not hindered by vertical or nearly vertical guides. In addition, the cradle 130 is small, such as approximately the size of a deck of cards, and may easily be located anywhere in the RV 102 without detracting from the aesthetics of the RV 102. Furthermore, the cradle 130 can be easily designed to match the interior design of the RV 102. Accordingly, the cradle 130 provides a freedom of design that has heretofore been lacking in the art. In addition, in some embodiments, the cradle 130 may not be stationary. For example, the cradle 130 may flip down from a wall of the RV 102 or swing into position when engaging the platform assembly 120. Such a design would further maximize the usable space in the living quarters of the RV 102.

Referring to FIGS. 2 and 4 the assembly 100 may preferably include at least one lock assembly in addition to the above-described brake to resist rotational movement of the motor. Specifically a first lock assembly 192 is connected to the motor housing 126, while a second lock assembly 194 is connected to the second housing 128. The lock assemblies 192, 194 prevent downward movement of the platform assembly 120 when it is in the upper position. Furthermore, in the preferred embodiment, the lock assemblies 192, 194 provide at least two points of engagement with the bed, which are preferably located at opposite ends of the bed. In the disclosed embodiment, this prevents potential injury to a driver or passenger of the RV 102. It is anticipated that an assembly 100 of the present invention may include no locking assemblies, a single locking assembly, or more than two locking assemblies.

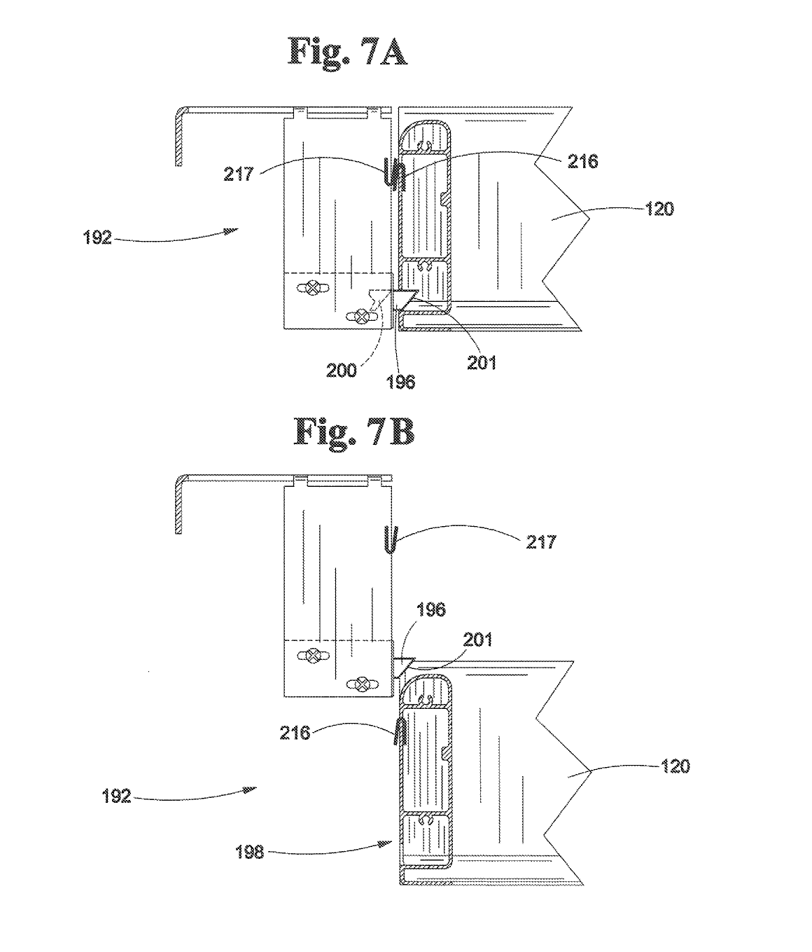

Turning to FIG. 7A, the locking assembly may have a locked position. In addition, the locking assembly may have an unlocked position, which is shown in FIG. 7B. The locking assemblies 192, 194 may be similar to door catch locks, which are known in the art. Furthermore, the locking assemblies, 192, 194 may be identical. As such one locking assembly 192 is discussed in detail. Referring to FIG. 7A, in the locked position, a latch 196 is located in a latch aperture 198 of the platform assembly 120. The latch aperture 198 is shown in FIGS. 2, 4, and 7B. Specifically, the latch aperture 198 is located in the first lateral frame member 140. Focusing on FIG. 7A, when the platform assembly 120 is in the upper position, the latch 196 is in communication with and extends into the latch aperture 198 to retain and lock the platform assembly 120 in the upper position.

When the assembly 100 is actuated to move the platform assembly to the lower position, a solenoid (not shown) is also activated to retract the latch 196 to an open position 200 shown in dotted lines in FIG. 7A. Accordingly, the platform assembly 120 may freely move downward. Once the solenoid ceases to activate the latch 196 to the open position 200, the latch 196 extends back to the locked position. As shown in FIG. 7B the latch 196 includes an angled surface 201. As the platform assembly is raised, it presses against the angled surface 201, which pushes the latch 196 toward the open position 200, allowing the platform assembly 120 to move above the latch 196 until the latch 196 reaches the latch aperture 198. When the latch 196 reaches the latch aperture 198, it extends into the latch aperture 198, thus locking the platform assembly 120 in the upper position. Also shown in FIGS. 7A and 7B are contacts 216, 217, which will be discussed in further detail below.

The preferred lock assemblies 192, 194 include a number of advantages. First, the lock assemblies 192, 194 do not require human interaction to operate. Rather, they are activated by the same electrical systems that activate the motor 144 to raise and lower the platform assembly 120. In addition, the lock assemblies 192, 194 do not require electrical power to remain locked. Rather, when the platform assembly 120 is in the upper position, the lock assemblies 192, 194 are not activated and do not require activation to remain locked. The default position is the locked position. Therefore, if there is a loss of power to the assembly 100, the platform assembly 120 will remain safely in the upper position, as the locks preferably are strong enough to hold the platform assembly 120 in the upper position. While the disclosed automatic locking assemblies 192, 194 offer the above-described advantages, it is anticipated that any type of lock may employed, including, manual locks. Furthermore, the lock assemblies 192, 194 may be reversed such that the latch 196 is located on the platform assembly 120, while the latch aperture 198 is fixed, such as on the motor housing 126 and/or second housing 128.

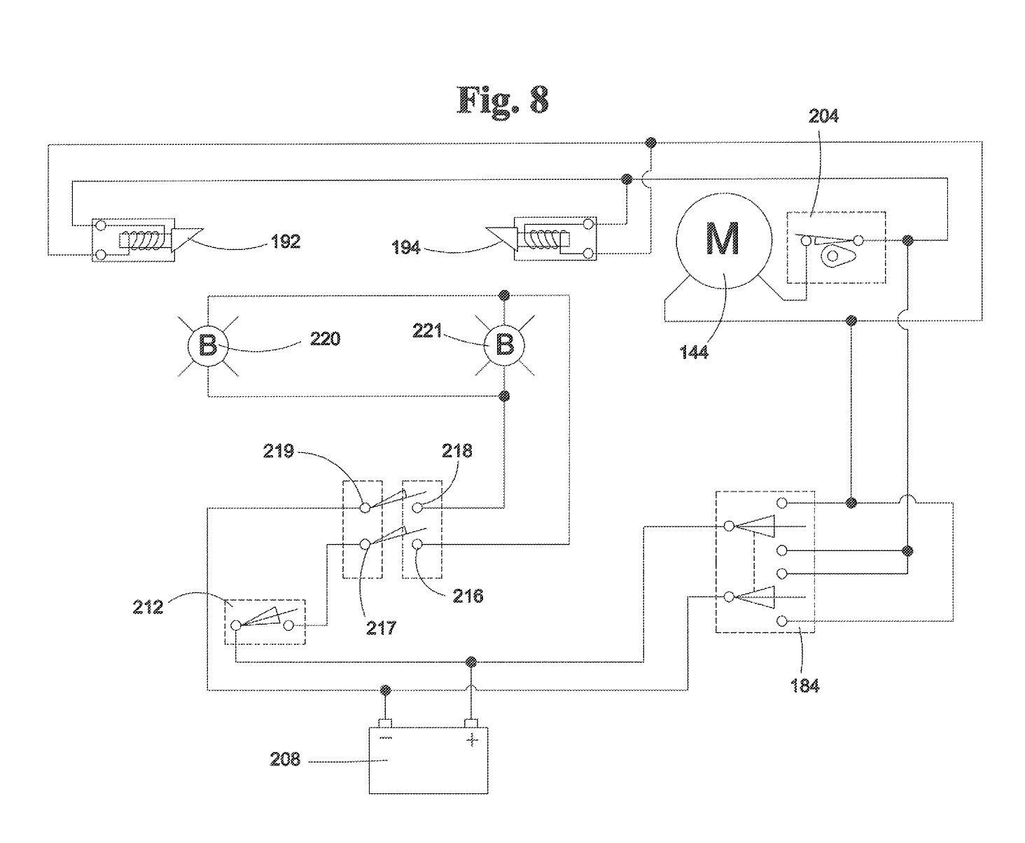

Referring to FIG. 8, an electrical wiring diagram of a preferred embodiment of a lift assembly 100 is provided. As will be appreciated by one of skill in the art, the described electrical wiring system is exemplary only and should not be construed as limiting. It is anticipated that many embodiments of an electrical wiring system may be used in a lift assembly 100 of the present invention. Furthermore, in the preferred embodiment, the wiring is located in the components of the assembly 100 such that they are not visible to a user. Shown is the switch 184 to raise and lower the platform assembly 120. The first locking assembly 192 and second locking assembly 194 are connected to the raise/lower switch 184. Also connected to the raise/lower switch is the motor 144, which, as described below in further detail, is reversible so as to both raise and lower the platform 120.

A limit switch 204 is also provided between the raise/lower switch 184 and the motor 144 as a safety feature, which will be discussed in further detail below. The limit switch 204 interrupts the power to the motor 144 when the platform assembly 120 has reached either its upper limit or lower limit. The upper limit refers to the position in which the platform assembly 120 is in the upper position. The lower limit refers to the position in which longitudinal frame member 136 engages the cradles 130, 131 or other means to position the platform assembly 120. In some embodiments of a lift assembly 100 at the present invention, multiple limit switches may be used. For example in a preferred embodiment, one limit switch may be used for raising the platform assembly 120, while a second limit switch may be used for lowering the platform assembly 120. In addition, as will be understood by one of skill in the art, it is anticipated that some motors 144 may include one, two, or more limit switches as purchased from a motor manufacturer.

In addition, the raise/lower switch 184 is connected to a battery 208. The battery 208 provides electrical power to the lift assembly 100. Also connected to the raise/lower switch 184 is a light switch 212. The light switch 212 is also operably connected to at least one set of contacts that is on the assembly 100. In the preferred embodiment, two contacts 217, 219 are located on a fixed portion of the assembly 100, such as the motor housing 126 and second housing 128. In addition, two contacts 216, 218 are located on a movable portion of the assembly 100, such as on the platform assembly 120. The contacts 216, 217, 218, 219 are connected to two lights 220, 221 that may be connected to the platform assembly 120, such as underneath the platform assembly 120.

A user may activate the raise/lower switch 184 to raise and lower the platform assembly 120. The user may hold the switch 184 in the up position to raise the platform assembly 120. Doing so provides power to the first lock assembly 192 and second lock assembly 194, which actuates same to move to their unlocked positions. Furthermore, as discussed above, the latch 196 includes an angled surface 201, which, in some embodiments, allows the platform assembly 120 to push the latch 196 out of the way as the platform assembly 120 is raised. In some embodiments, a combination of electrical actuation and physical movement by the platform assembly may move the latch 196 of each locking assembly 192, 194 to its open position. When the switch 184 is released, the power to the locking assemblies 192, 194 is discontinued. At that point, the latch 196 extends into the latch aperture 198 to hold the platform assembly 120 in the upper position.

In addition to actuation of the lock assemblies 192, 194, activation of the switch to the raise position will provide the correct polarity to actuate the motor 144 to rotate such that the platform assembly 120 is raised. Specifically, in the preferred embodiment, the motor 144 provides rotational movement to wind the movable members 121, 122, 123, 124 about same. Accordingly, the platform assembly 120 is raised. Referring again to the limit switch 204, it may be configured to prevent the platform assembly 120 from moving upward when it is carrying a load that is greater than a predetermined weight. In the disclosed embodiment, this safety feature prevents the bed from raising when a person is on same. However, as will be appreciated by one of skill in the art, there are embodiments of a lift assembly 100 wherein such a feature will not be beneficial. In the preferred embodiment, the limit switch 204 includes at least one fuse that will blow when the assembly 100 attempts to lift a load above the predetermined weight. In such a case, the motor 144 draws too much current, which blows the fuse. Any type of fuse known in the art, now or in the future, may be used. However, a fuse that may automatically reset once the load is removed from the platform assembly 120 is preferred.

The assembly may also include at least one light, preferably on the bottom of the platform assembly 120. In the illustrated embodiment, two lights 220, 221 are provided. The lights 220, 221 are activated by the movable contacts 216, 218 located on the platform assembly 120 reaching the fixed contacts 217, 219 located on the motor housing 126 and second housing 128. Contacts 216, 217 are also shown in FIGS. 7A and 7B. When the raise/lower switch 184 is activated to raise the platform assembly 120, power is also supplied to the contacts 217, 219 on the motor housing 126 and second housing 128. When the sets of contacts 216, 217, 218, 219 meet each other in the upper position, power is supplied to the lights 220, 221 on the bottom of the platform assembly 120. Accordingly, users of the RV 102, may use the lights for overhead lighting. However, a light switch 212 is also provided to turn the lights 220, 221 off and on as necessary. In addition, the lights 220, 221 provide the user with a simple means of determining whether the platform assembly 120 has indeed reached the upper position. At that time, the user may stop activating the raise/lower switch 184. It is anticipated that other embodiments of contacts may be used. For example, the contacts could be configured to provide a signal to the user when the assembly 100 is moving in either direction.

Once in the upper position, the user stops activating the switch; therefore, power is no longer supplied to the first locking assembly 192, second locking assembly 194, and motor 144. Accordingly, the motor 144 is no longer operating and the brake is preventing further movement of the motor 144. Moreover, the first locking assembly 192 and second locking assembly 194 are each in their locked positions, preventing downward movement of the platform assembly 120. The opposite series of events will lower the platform assembly 120. Namely, a user may activate the raise/lower switch 184 downward to lower the platform assembly 120. Doing so actuates the first locking assembly 192 and second locking assembly 194 to move the latch 196 to the retract position. The brake of the motor 144 is also actuated to allow movement of the motor 144. The motor 144 is provided with the proper polarity to unwind the movable members 121, 122,13, and 124. Furthermore, as the contacts 216, 218 move away from contacts 217, 219, the lights 220, 221 no longer receive power. The raise/lower switch 184 is activated by the user until the platform assembly 120 reaches the lower position. At that time, the user releases the switch 184, and power is no longer provided to the assembly 100.

Turning to FIG. 9, an alternative embodiment of an assembly 100 of the present invention is provided in the lower position. Shown is the platform assembly 120 two cradles 130, 131, a mattress 125, the first longitudinal frame member 136, and two movable members 122, 124. Also shown is the motor housing 126 and second housing 128, to which the second locking assembly 194 is attached. Additionally, in the alternative embodiment, the assembly 100 includes a longitudinal privacy member 224, a first lateral privacy member 226, and a second lateral privacy member 228. The privacy members 224, 226, 228 may be made of any material known in the art; however, fabric intertwined with scrim is preferred. Such a fabric is rigid in one direction, preferably the lateral direction. Furthermore, the fabric may be strong enough to provide the added feature of preventing a person, such as a child, from falling out of the assembly 100. In addition, the fabric provides privacy, as the illustrated embodiment is located near the windshield 108, driver's window 112, and passenger window (not shown) of the RV 102. The privacy members 224, 226, 228 may be attached to the assembly 100 in any manner known in the art, now or in the future. In the illustrated embodiment, snaps 230 are provided to attach the privacy members 224, 226, 228. It is anticipated that in some embodiments, the privacy members 224, 226, 228 could be attached to a tubular motor to raise and lower with the platform assembly 120. In addition, in some embodiments, the lateral privacy members 226, 228 could be the movable members for raising and lowering the platform assembly 120. In such an embodiment, it is anticipated that the members would be approximately thirty (30) inches wide and prevent rocking in the rigid direction(s). In other embodiments, the privacy members 224 226, 228 may be connected to the ceiling 118 of the RV 102 only or in addition to the assembly 100.

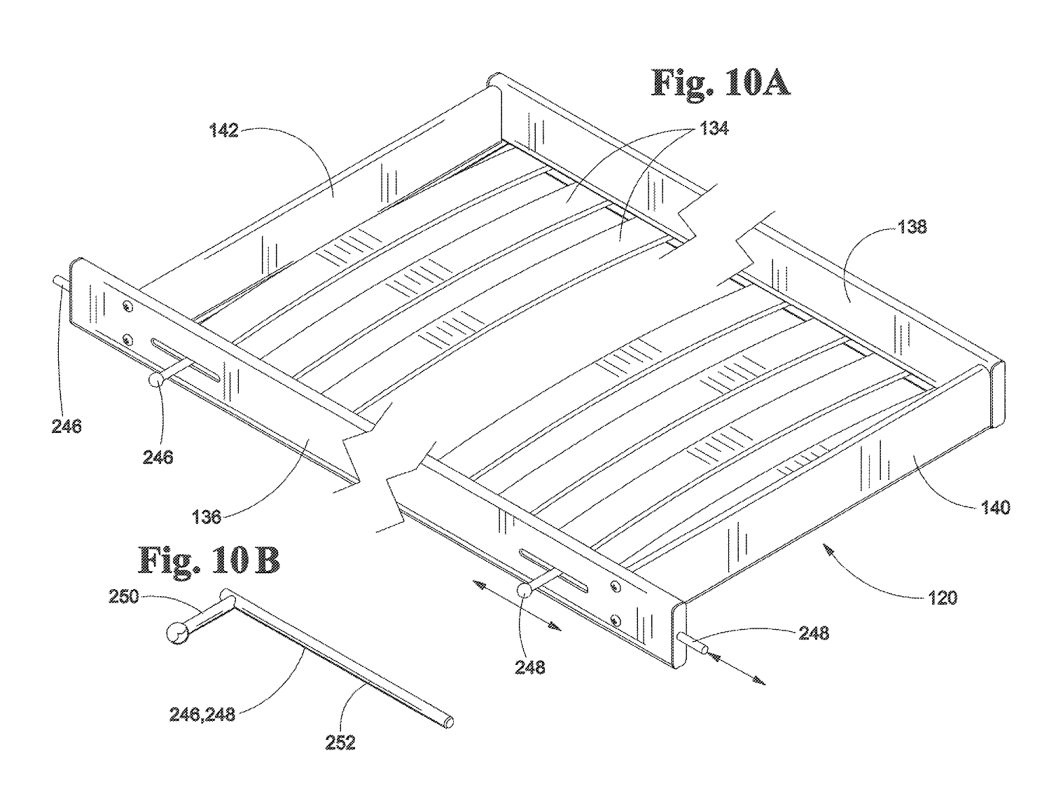

Referring to FIG. 10A, a third embodiment of a lift assembly 100 of the present invention is provided. Shown is the platform assembly 120, including the first longitudinal frame member 136, second longitudinal frame member 138, first lateral frame member 140, second lateral frame member 142, and slats 134. Also shown is a latch to position the platform assembly 120 in the lower horizontal plane. Specifically, the platform assembly 120 includes two sliding lock pins 246, 248. In this embodiment, the sliding lock pins 246, 248 provide means for positioning the platform assembly 120 in the lower horizontal plane 158 (shown in FIGS. 1A and 2). Accordingly, the platform assembly 120 is secured in the lower position by the sliding lock pins 246, 248. As will be understood by one of skill in the art, in some embodiments only one sliding pin may be used, while in other embodiments, more than two sliding pins may be employed. As shown in FIG. 10B, the platform assembly 120 may include the first and second sliding lock pins 246, 248. However, it is anticipated that the platform assembly 120 may also receive the sliding lock pins 246, 248. Referring to FIG. 10B, the sliding locks pins 246, 248, which may be identical, each include a handle 250 and a latching portion 252. In the lower position, the operator slides the locking pins outward via the handle 250 to engage a hole or slot (not shown) in the adjacent wall of the RV 102 or other vehicle or device. This feature eliminates the need for a cradle 130 while adding the complexity of another component to the platform assembly 120.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications variations, improvements, and/or substantial equivalents.

1. A lift assembly comprising:
a platform assembly, said platform assembly movable between an upper position and a lower position;
said lower position located in a lower horizontal plane than said upper position;
at least one movable member connected to said platform assembly and which may be activated to perform functions selected from the group consisting of raising said platform assembly, lowering said platform assembly, and combinations thereof; and
means for positioning said platform assembly in said lower horizontal plane.

2. The lift assembly of claim 1 further comprising a plurality of movable members.

3. The lift assembly of claim 2 wherein said plurality of movable members is activated to perform said functions by an electric motor.

4. The lift assembly of claim 3 wherein said electric motor is a tubular motor.

5. The lift assembly of claim 3 wherein said lift assembly further comprises a brake to selectively resist motion of said electric motor.

6. The lift assembly of claim 5 wherein said brake is a spring actuated rubber faced disc.

7. The lift assembly of claim 1 further comprising a lock assembly to prevent downward movement of said platform assembly when said platform assembly is in said upper position, said lock assembly having a locked position and an unlocked position, and said lock assembly in contact with said platform assembly in said locked position to prevent downward movement of said platform assembly.

8. The lift assembly of claim 1 further comprising at least one privacy member.

9. The lift assembly of claim 1 wherein said movable member is selected from the group consisting of a web belt, cable, strap, chain, stretch resistant fabric, and combinations thereof.

10. The lift assembly of claim 9 wherein said movable member is a web belt.

11. A lift assembly comprising:
a platform assembly, said platform assembly movable between an upper position and a lower position said platform assembly including a bed;
said lower position located in a lower horizontal plane than said upper position;
at least one movable member connected to said platform assembly and which may be activated by a motor to perform functions selected from the group consisting of raising said platform assembly, lowering said platform assembly, and combinations thereof; and
at least one cradle receiving said platform assembly in said lower position, said at least one cradle positioning said platform in said lower horizontal plane.

12. The lift assembly of claim 11 wherein said cradle comprises a horizontal portion and at least one vertical portion.

13. The lift assembly of claim 12 wherein said cradle comprises two vertical portions.

14. The lift assembly of claim 11 further comprising a plurality of movable members.

15. The lift assembly of claim 14 wherein said motor is an electric motor providing rotational movement to raise and lower said plurality of movable members.

16. The lift assembly of claim 11 further comprising a lock assembly to prevent downward movement of said platform assembly, said lock assembly having a locked position and an unlocked position, and said lock assembly in contact with said platform assembly in said locked position to prevent downward movement of said platform assembly.

17. A lift assembly comprising:
a platform assembly, said platform assembly movable between an upper position and a lower position, said platform assembly including a bed;
said lower position located in a lower horizontal plane than said upper position;
at least one movable member connected to said platform assembly and which may be activated by a motor to perform functions selected from the group consisting of raising said platform assembly, lowering said platform assembly, and combinations thereof; and
said platform assembly further comprising at least one latch, said latch positioning said platform in said lower horizontal plane.

18. The lift assembly of claim 17 further comprising a plurality of movable members.

19. The lift assembly of claim 18 wherein said motor is an electric motor providing rotational movement to raise and lower said plurality of movable members.

20. The lift assembly of claim 19 further comprising a lock assembly to prevent downward movement of said platform assembly, said lock assembly having a locked position and an unlocked position, and said lock assembly in contact with said platform assembly in said locked position to prevent downward movement of said platform assembly.
